(19) United States
(12) Patent Application Publication
(10) Pub. No.: US 2016/0295194 A1
(43) Pub. Date: Oct. 6, 2016

(54) STEREOSCOPIC VISION SYSTEM GENERATNG STEREOSCOPIC IMAGES WITH A MONOSCOPIC ENDOSCOPE AND AN EXTERNAL ADAPTER LENS AND METHOD USING THE SAME TO GENERATE STEREOSCOPIC IMAGES

(71) Applicant: Ming Shi CO., LTD., Changhua City (TW)

(72) Inventors: Tong-Wen Wang, Changhua City (TW); Yen-Yu Wang, Changhua City (TW); Atul Kumar, Changhua City (TW); Wan-Chi Hung, Changhua City (TW); Kai-Che Liu, Changhua City (TW)

(73) Assignee: Ming Shi CO., LTD., Changhua City (TW)

(21) Appl. No.: 14/672,325

(22) Filed: Mar. 30, 2015

(51) Int. Cl. H04N 13/02; G02B 23/24; G06T 7/00; H04N 13/00; H04N 13/04

(52) U.S. Cl. CPC H04N 13/026; H04N 13/0029; H04N 13/0022; H04N 13/0246; H04N 13/0402; G06T 7/002; G06T 7/0075; G02B 23/2415; G02B 23/2484; G06T 2207/10012; G06T 2210/41

(57) ABSTRACT

A stereoscopic vision system includes a monoscopic endoscope, an external adapter lens, and a camera calibration and stereoscopic processing unit. The external adapter lens has two tubes formed therein for forming two optical paths and is mounted on the endoscope for a CCD of the endoscope to receive parallax image pairs of an observed object. Each parallax image pair has a left image and a right image thereon. The camera calibration and stereoscopic processing unit receives the parallax image pairs, and calibrates two camera systems formed by the adapter lens and the endoscope and processes the parallax image pairs generated from the calibration to generate stereoscopic images to be displayed on a display. The simple and inexpensive two-tube external adapter lens directly mounted on any type of monoscopic endoscope without modifying the monoscopic endoscope and one-time camera calibration ensures cost effectiveness and operational convenience.

### BACKGROUND OF THE INVENTION

1. Field of the Invention

The present invention relates to a monoscopic endoscope, and more particularly, to a stereoscopic vision system including a monoscopic endoscope and an external adapter lens mounted on the endoscope and having dual optical lens to generate 2D parallax image pairs from two different view angles and create stereoscopic images from the 2D parallax image pairs and a method using the stereoscopic vision system to generate stereoscopic images.

2. Description of the Related Art Endoscope is the kernel of minimally invasive surgery (MIS), which is the procedure of choice for the treatment of many diseases. Majority of the current endoscope systems are primarily based on monoscopic (single-camera system) endoscope. The drawback of single-camera system resides in no depth information. To tackle the issue, the surgeon needs to use cues, such as instrument motion and the like, to get depth perception.

However, movement of the monoscopic endoscope in a complex surgical task and a very small operating space is sensitive and restricted. Currently, the stereoscopic vision during minimally invasive surgery adopts endoscopes with two camera systems. Although there are various methods proposed for using single camera system to obtain stereoscopic images which calculate the depth map using cues, such as motion, and modifying the optical system of the camera, most of these methods cannot be directly added to the currently available single camera endoscope system.

### SUMMARY OF THE INVENTION

An objective of the present invention is to provide a stereoscopic vision system generating stereoscopic images with a monoscopic endoscope and an external adapter lens and a method using the stereoscopic vision system to generate stereoscopic images for ensuring cost effectiveness and operational convenience without modifying the structure of the monoscopic endoscope. To achieve the foregoing objective, the stereoscopic vision system generating stereoscopic images with a monoscopic endoscope and an external adapter lens to generate stereoscopic images includes an external adapter lens, a monoscopic endoscope, a camera calibration stereoscopic processing unit, and a stereoscopic display unit.

The external adapter lens has two tubes formed therein for forming two optical paths through two different view angles.

The external adapter lens is mounted on a distal end of the monoscopic endoscope to constitute two camera systems for a video stream of an observed object in the form of continuous 2D (Two-dimensional) parallax image pairs to be captured by a CCD (Charge-coupled Device) of the monoscopic endoscope through the two tubes of the external adapter lens. Each 2D parallax image pair on the CCD at a time contains a left image and a right image of the observed object respectively occupying a left half and a right half of the entire area of the CCD.

The camera calibration and stereoscopic processing unit is connected to the monoscopic endoscope to receive the 2D parallax image pairs from the monoscopic endoscope and is built in with a camera calibration process for calibrating the two camera systems using the 2D parallax image pairs to acquire and calibrate intrinsic parameters associated with the two camera systems, and a real-time stereoscopic vision generation process for processing the 2D parallax image pairs generated from the two calibrated camera systems to generate corresponding stereoscopic images on a real-time basis.

The stereoscopic display unit is connected to the camera calibration and stereoscopic processing unit, supports a 3D (Three-dimensional) display format of the stereoscopic images transmitted from the camera calibration and stereoscopic processing unit, and displays the stereoscopic images thereon.

Given the foregoing stereoscopic vision system, the two-tube external adapter lens can be directly mounted on the monoscopic endoscope to create two camera systems capable of generating real-time stereoscopic images without having to modify the monoscopic endoscope at all, the calibration of the two camera systems formed by the external adapter lens and the monoscopic endoscope just needs to be performed once as long as the combination of the external adapter lens and the monoscopic endoscope remains unchanged, and the calibration of the two camera systems and the generation of real-time stereoscopic images can be performed through the camera calibration and stereoscopic processing unit with the stereoscopic images further displayed on a 3D display. Accordingly, stereoscopic images can be generated with a conventional monoscopic endoscope, a simple and inexpensive external adapter lens mounted on the monoscopic endoscope, and algorithms for calibrating the two camera systems and processing the 2D parallax images of the two calibrated camera systems, thereby ensuring cost effectiveness and operational convenience.

To achieve the foregoing objective, the method using a stereoscopic vision system to generate stereoscopic images is performed by a stereoscopic vision system having a 3D (Three-dimensional) display, a monoscopic endoscope, and an external adapter lens mounted on the monoscopic endoscope and having two tubes formed therein with two different view angles. The method has steps of:

receiving a video stream of an observed object in the form of continuous 2D (Two-dimensional) parallax image pairs to be captured by a CCD (Charge-coupled Device) of the monoscopic endoscope through the two tubes of the external adapter lens, wherein each 2D parallax image pair on the CCD at a time conforms to a side-by-side format and contains a left image and a right image of the observed object respectively passing through two camera systems and projected on a left half and a right half of an entire area of the CCD;

determining intrinsic parameters associated with the two camera systems and calibrating the intrinsic parameters for just one time;

processing the 2D parallax image pairs generated from the two calibrated camera systems to generate corresponding stereoscopic images on a real-time basis; and

displaying the stereoscopic images on the 3D display supporting the format of the stereoscopic images.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a stereoscopic vision system in accordance with the present invention;

FIG. 2 is a schematic view of a left image and a right image captured on a CCD of an endoscope through an external adapter lens of the system in FIG. 1;

FIG. 3 is a flow diagram of a camera calibration process in accordance with the present invention;

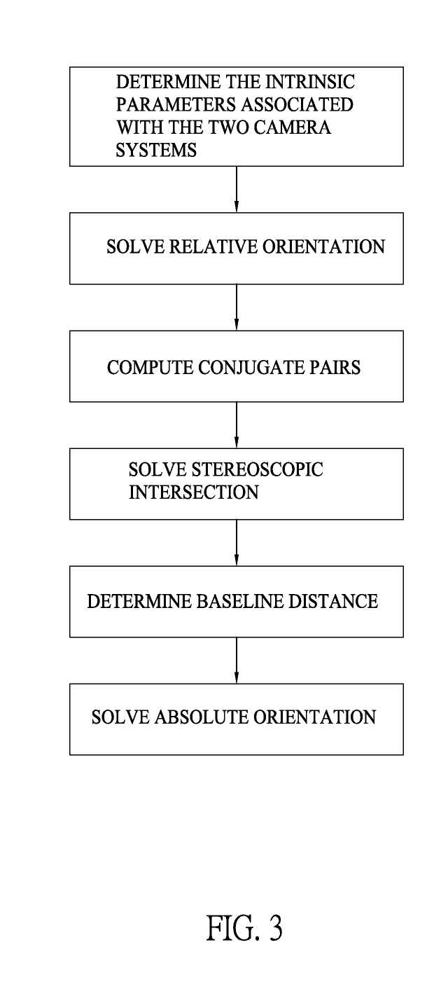

FIG. 4 is a flow diagram of a real-time stereoscopic vision generation process in accordance with the present invention; and

FIG. 5 is a flow diagram of a method using the stereoscopic vision system to generate stereoscopic images in accordance with the present invention.

### DETAILED DESCRIPTION OF THE INVENTION

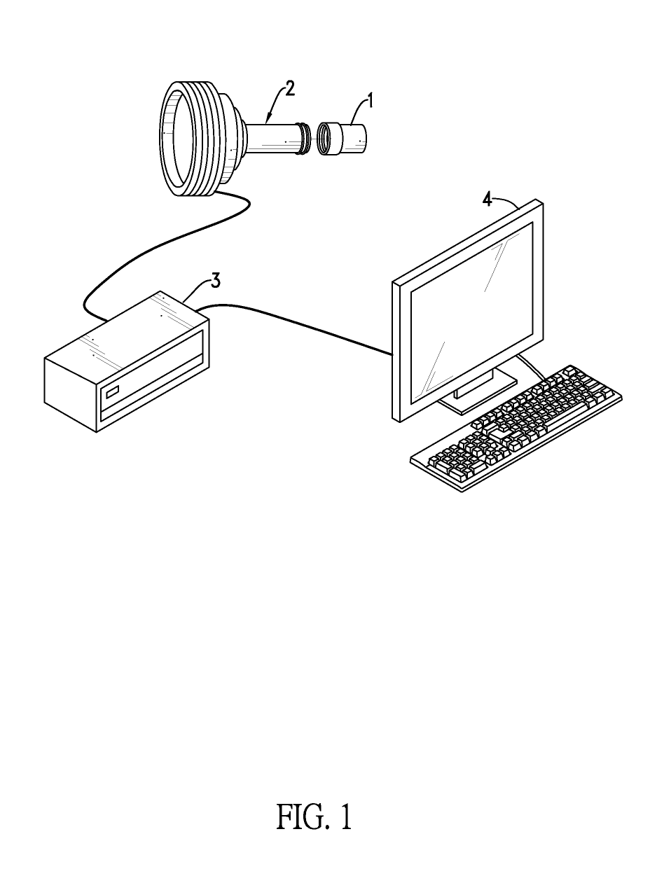

With reference to FIG. 1, a stereoscopic vision system in accordance with the present invention includes an external adapter lens 1, a monoscopic endoscope 2, a camera calibration and stereoscopic processing unit 3, and a stereoscopic display unit 4.

The external adapter lens 1 has two tubes formed therein for forming two optical paths through two different view angles.

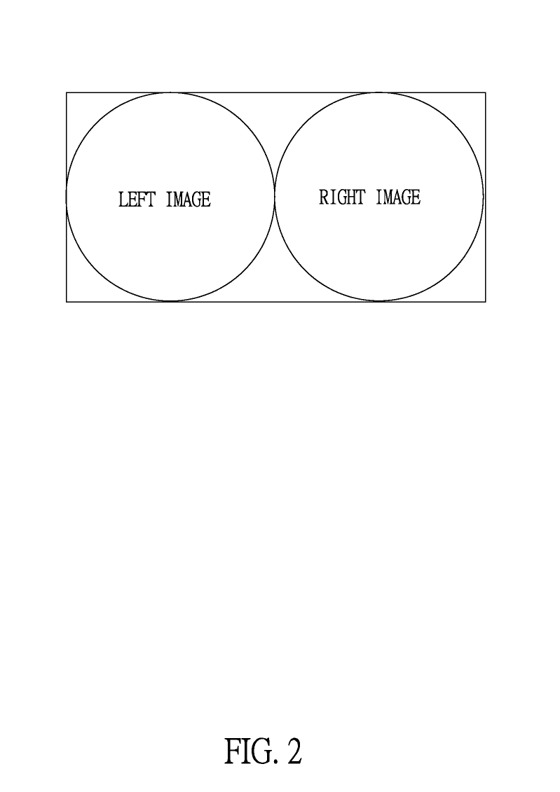

The monoscopic endoscope 2 is a single-camera system. The external adapter lens 1 is detachably mounted on a distal end of the monoscopic endoscope 2 for a video stream of an observed object in the form of continuous 2D (Two-dimensional) parallax image pairs to be captured by a CCD (Charge-coupled Device) of the monoscopic endoscope 2 through the two tubes of the external adapter lens 1. With reference to FIG. 2, each 2D parallax image pair on the CCD at a time contains a left image and a right image of the observed object respectively occupying a left half and a right half of the entire area of the CCD to simulate images generated by two camera systems formed by the monoscopic endoscope 2 and the two-tube external adapter lens 1 and serve as raw images with the side-by-side format to be further processed as stereoscopic images for the left eye and the right eye of a user.

The camera calibration and stereoscopic processing unit 3 is connected to the monoscopic endoscope 2 to receive the 2D parallax image pairs from the monoscopic endoscope 2, and is built in with a camera calibration process to calibrate the two camera systems using the 2D parallax image pairs projected on the CCD of the monoscopic endoscope 2 through the two-tube external adapter lens 1. The camera calibration and stereoscopic processing unit 3 may be a computer. The two camera systems need to be calibrated due to different parameters intrinsic to each camera necessary to link the pixel coordinate of an image point with the corresponding coordinates in the camera reference frame, such as focal length, pixel scale, optical center, pixel skew and the like. Therefore, the camera calibration process has steps of determining the intrinsic parameters associated with the two camera systems, solving relative orientation, computing conjugate pairs, solving stereoscopic intersection, determining baseline distance, and solving absolute orientation. After the camera calibration process is completed, there is only a horizontal shift between two conjugate points of any same scene point on the left image and the right image of each 2D parallax image pair. Unless the combination of the external adapter lens 1 and the monoscopic endoscope 2 varies, the camera calibration process is only performed once. The calibrated 2D parallax image pairs can then be used as raw images for stereoscopic vision during real-time stereoscopic display.

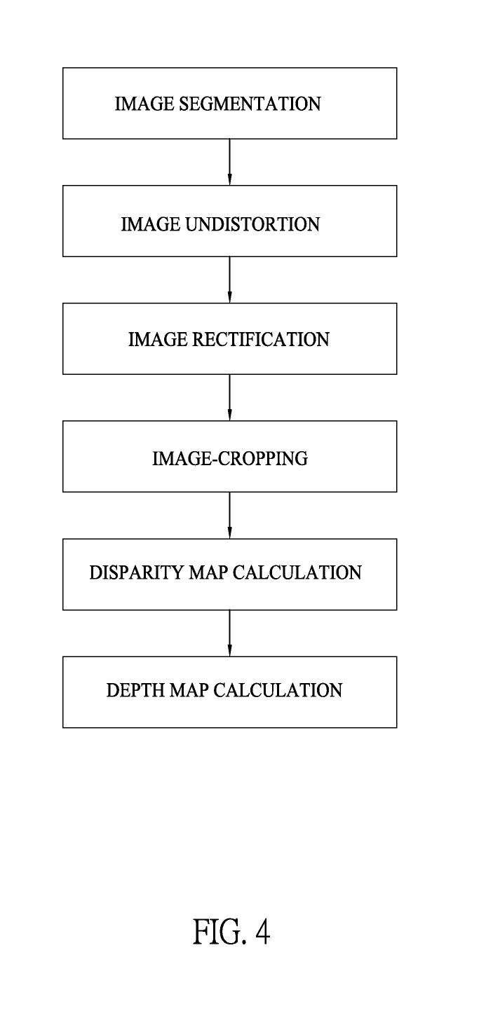

With reference to FIG. 4, the camera calibration and stereoscopic processing unit 3 further has a real-time stereoscopic vision generation process built therein. The real-time stereoscopic vision generation process includes an image segmentation step, an image undistortion step, an image rectification step, an image-cropping step, and a disparity map calculation step, which are sequentially performed by the camera calibration and stereoscopic processing unit 3. In the image segmentation step, image processing techniques are applied to segment the left image and the right image in each 2D parallax image pair. In the image undistortion step, optical distortion from the two camera systems and image distortion from the 2D parallax image pairs are removed. In the image rectification step, the conjugate epipolar lines of the left image and the right image are arranged to be collinear and parallel to one of the image axes of the left image and right image. In the image-cropping step, the rectified left image and right image are cropped. In the disparity map calculation step, the disparity map can be obtained by extracting a plane orientation at each pixel via the left image or the right image. The disparity map together with the cropped left image and right image of each 2D parallax image pair constitute a corresponding stereoscopic image to be displayed on a glasses type 3D display supporting the side-by-side format or the interlaced format. The real-time stereoscopic vision generation process may further include a depth map calculation step to calculate a depth map from the disparity map or by calculating an epipolar geometry (including epipolar lines and epipoles) or a fundamental matrix of the rectified left image and right image in each 2D parallax image pair. The depth map together with the cropped left image and right image constitute a corresponding stereoscopic image to be displayed on any glasses-free 3D display. It is noted that the disparity map calculation and the depth map calculation are only required upon generating 3D images displayed on a glasses-free 3D display, and the real-time stereoscopic vision generation process from the image segmentation step to the image-cropping step suffices the generation of 3D images displayed on a glasses type 3D display.

The stereoscopic display unit 4 is connected to the camera calibration and stereoscopic processing unit 3, serves to display the stereoscopic images or stereoscopic video stream transmitted from the camera calibration and stereoscopic processing unit 3, and may be a glasses type 3D display supporting the side-by-side format and the interlaced image format or a glasses-free 3D display for stereoscopic image.

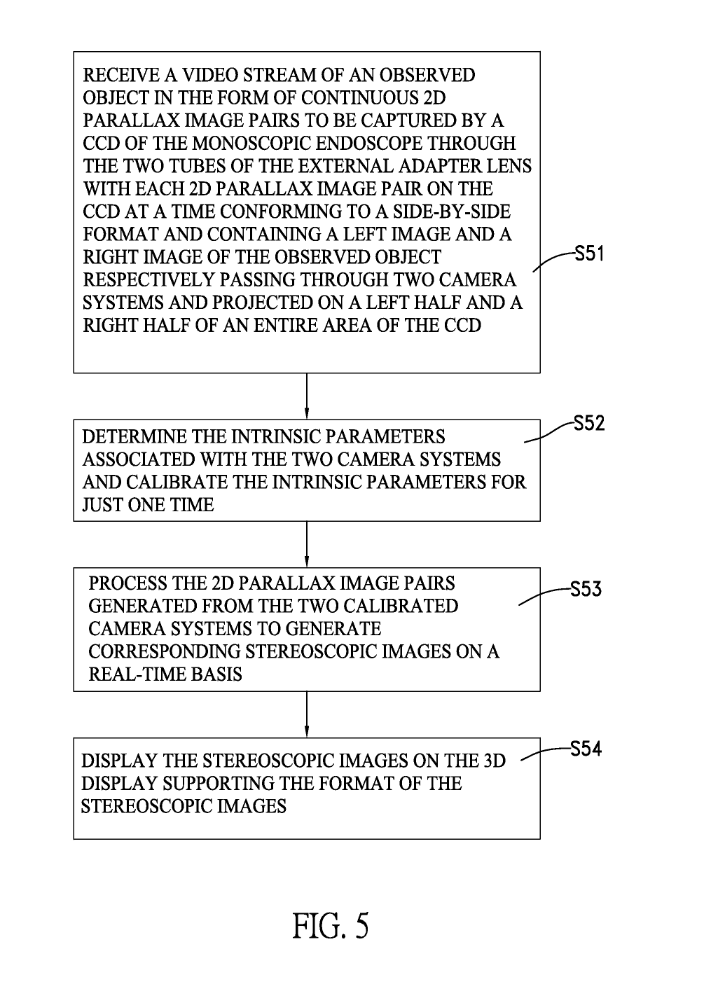

With reference to FIG. 5, a method using the stereoscopic vision system to generate stereoscopic images in accordance with the present invention is performed by a stereoscopic vision system with a monoscopic endoscope and an external adapter lens and includes the following steps.

Step S51: Receive a video stream of an observed object in the form of continuous 2D parallax image pairs to be captured by a CCD (Charge-coupled Device) in the monoscopic endoscope through the two tubes of the external adapter lens. The external adapter lens has two tubes formed therein for forming two optical paths through two different view angles. Each 2D parallax image pair on the CCD at a time conforms to the side-by-side format and contains a left image and a right image of the observed object respectively passing through two camera systems represented by the two tubes of the external adapter lens and the monoscopic endoscope and projected on a left half and a right half of the entire area of the CCD.

Step S52: Determine the intrinsic parameters associated with the two camera systems and calibrate the intrinsic parameters for just one time.

Step S53: Process the 2D parallax image pairs of the two calibrated camera systems to generate corresponding stereoscopic images on a real-time basis. The 2D parallax image pairs are processed by segmenting the left image and the right image in each 2D parallax image pair, removing optical distortion arising from the two camera systems and image distortion arising from the left image and the right image, rectifying the left image and the right image, cropping the rectified left image and right image, and calculating a disparity map associated with the left image and the right image to generate a stereoscopic image to be displayed on a glasses type 3D display supporting the side-by-side format or the interlaced format on a real-time basis. Each 2D parallax image may be further processed by calculating a depth map from the disparity map associated with the 2D parallax image to generate a stereoscopic image to be displayed on a glasses-free 3D display.

Step S54: Display the stereoscopic images on a 3D display supporting the format of the stereoscopic images.

In sum, the stereoscopic vision system and the method in accordance with the present invention employs an external adapter lens with two tubes to create two camera systems in collaboration with a monoscopic endoscope, such that camera calibration for the two camera systems and stereoscopic processing for the 2D parallax image pairs captured on the CCD of the monoscopic endoscope can be performed to generate stereoscopic images to be displayed on a 3D display. The present invention is advantageous in the use of a simple and inexpensive two-tube external adapter lens that can be directly mounted on any type of monoscopic endoscope without modifying the monoscopic endoscope and one-time camera calibration for the two camera systems, thereby ensuring cost effectiveness and operational convenience.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A stereoscopic vision system generating stereoscopic images with a monoscopic endoscope and an external adapter lens, comprising:
an external adapter lens having two tubes formed therein for forming two optical paths through two different view angles;
a monoscopic endoscope, wherein the external adapter lens is detachably mounted on a distal end of the monoscopic endoscope to constitute two camera systems for a video stream of an observed object in the form of continuous 2D (Two-dimensional) parallax image pairs to be captured by a CCD (Charge-coupled Device) of the monoscopic endoscope through the two tubes of the external adapter lens, and each 2D parallax image pair on the CCD at a time contains a left image and a right image of the observed object respectively occupying a left half and a right half of an entire area of the CCD;
a camera calibration and stereoscopic processing unit connected to the monoscopic endoscope to receive the 2D parallax image pairs from the monoscopic endoscope and built in with a camera calibration process for calibrating the two camera systems using the 2D parallax image pairs to acquire and calibrate intrinsic parameters associated with the two camera systems, and a real-time stereoscopic vision generation process for processing the 2D parallax image pairs generated from the two calibrated camera systems to generate corresponding stereoscopic images on a real-time basis; and
a stereoscopic display unit connected to the camera calibration and stereoscopic processing unit, supporting a 3D (Three-dimensional) display format of the stereoscopic images transmitted from the camera calibration and stereoscopic processing unit, and displaying the stereoscopic images thereon.

2. The stereoscopic vision system as claimed in claim 1, wherein the camera calibration process has steps of determining the intrinsic parameters associated with the two camera systems, solving relative orientation, computing conjugate pairs, solving stereoscopic intersection, determining baseline distance, and solving absolute orientation, and after the camera calibration process is completed, only a horizontal shift is present between two conjugate points of any same scene point on the left image and the right image of each 2D parallax image pair generated from the two calibrated camera systems.

3. The stereoscopic vision system as claimed in claim 2, wherein the real-time stereoscopic vision generation process has:
an image segmentation step segmenting the left image and the right image in each 2D parallax image pair generated from the two calibrated camera systems;
an image undistortion step removing optical distortion from the two camera systems and image distortion from the left image and the right image;
an image rectification step arranging conjugate epipolar lines of the left image and the right image to be collinear and parallel to one of image axes of the left image and the right image;
an image cropping step;
a disparity map calculation step calculating a disparity map by extracting a plane orientation at each pixel via the left image or the right image; and
a depth map calculation step calculating a depth map from the disparity map or by calculating an epipolar geometry including epipolar lines and epipoles or a fundamental matrix of the rectified left image and right image;
wherein the image segmentation step, the image undistortion step, the image rectification step, the disparity map calculation step and the depth map calculation step are sequentially performed by the camera calibration and stereoscopic processing unit.

4. The stereoscopic vision system as claimed in claim 3, wherein the stereoscopic images are generated by the left images and the right images in the 2D parallax image pairs generated from the two calibrated camera systems and the disparity maps corresponding to the 2D parallax image pairs, and are displayed on the stereoscopic display unit pertaining to a glasses type 3D display supporting a side-by-side format or an interlaced format for stereoscopic display.

5. The stereoscopic vision system as claimed in claim 3, wherein the stereoscopic images are generated by the left images and the right images in the 2D parallax image pairs generated from the two calibrated camera systems and the depth maps corresponding to the 2D parallax image pairs, and are displayed on the stereoscopic display unit pertaining to a glasses-free 3D display.

6. A method using a stereoscopic vision system to generate stereoscopic images performed by a stereoscopic vision system having a 3D (Three-dimensional) display, a monoscopic endoscope, and an external adapter lens mounted on the monoscopic endoscope and having two tubes formed therein with two different view angles, the method comprising steps of:
receiving a video stream of an observed object in the form of continuous 2D (Two-dimensional) parallax image pairs to be captured by a CCD (Charge-coupled Device) of the monoscopic endoscope through the two tubes of the external adapter lens, wherein each 2D parallax image pair on the CCD at a time conforms to a side-by-side format and contains a left image and a right image of the observed object respectively passing through two camera systems and projected on a left half and a right half of an entire area of the CCD;
determining intrinsic parameters associated with the two camera systems and calibrating the intrinsic parameters for just one time;
processing the 2D parallax image pairs generated from the two calibrated camera systems to generate corresponding stereoscopic images on a real-time basis; and
displaying the stereoscopic images on the 3D display supporting the format of the stereoscopic images.

7. The method as claimed in claim 6, wherein the step of calibrating the intrinsic parameters further has steps of:
solving relative orientation;
computing conjugate pairs;
solving stereoscopic intersection;
determining baseline distance; and
solving absolute orientation;
wherein after the step of calibrating the intrinsic parameters is completed, only a horizontal shift is present between two conjugate points of any same scene point on the left image and the right image of each 2D parallax image pair generated from the two calibrated camera systems.

8. The method as claimed in claim 6, wherein in the step of processing the 2D parallax image pairs, the 2D parallax image pairs generated from the two camera systems are processed by segmenting the left image and the right image in each 2D parallax image pair, removing optical distortion arising from the two camera systems and image distortion arising from the left image and the right image, rectifying the left image and the right image, cropping the rectified left image and right image, calculating a disparity map associated with the left image and the right image of each 2D parallax image pair generated from the two camera systems to generate a corresponding stereoscopic image to be displayed on a glasses type 3D display supporting the side-by-side format or the interlaced format, and calculating a depth map from the disparity map to generate a stereoscopic image to be displayed on a glasses-free 3D display.
